(19) United States
(12) Patent Application Publication
(10) Pub. No.: US 2024/0209293 A1
(43) Pub. Date: Jun. 27, 2024

(54) SOAP MAKING SYSTEM AND METHOD

(71) Applicant: BERRY CLEAN BRANDS, INC., Clarkston, MI (US)

(72) Inventor: Jessica Black, Clarkston, MI (US)

(21) Appl. No.: 18/531,841

(22) Filed: Dec. 7, 2023

Related U.S. Application Data
(60) Provisional application No. 63/435,457, filed on Dec. 27, 2022.

(51) Int. Cl. C11D 13/10; C11D 9/02

(52) U.S. Cl. CPC C11D 13/10; C11D 9/02

(57) ABSTRACT

A soap making system includes a lye vessel configured to receive a first material, an oil vessel configured to receive a second material, and a blending vessel configured to receive the first material from the lye vessel and the second material from the oil vessel. The lye vessel may include a lye vessel heat energy source and a lye vessel mixer to heat and blend the first material. The oil vessel may include an oil vessel heat energy source and an oil vessel mixer to heat and blend the second material. The blending vessel may include a blending vessel mixer to blend the first material with the second material to produce a soap. A control system to facilitate a forming of the soap may be provided in communication with the lye vessel, the oil vessel, and the blending vessel, for selectively controlling an operation of the soap making system.

### CROSS-REFERENCE TO RELATED APPLICATIONS

This application claims the benefit of U.S. Provisional Application Ser. No. 63/435,457, filed on Dec. 27, 2022. The entire disclosure of the above application is incorporated herein by reference.

### FIELD

The present technology relates to making soap and, more specifically, to a system and method for facilitating the making of soap.

### INTRODUCTION

This section provides background information related to the present disclosure which is not necessarily prior art.

Systems and methods for making soap date back thousands of years. Many of the known systems and methods are for relatively small-scale production of soap that typically require substantial manual labor. Such small-scale systems and methods expose an operator to a risk of injury due to the handling of a lye (e.g., sodium hydroxide) and fumes from the lye. Furthermore, the manual nature of these small-scale systems and methods can lead to inconsistency in the soap that is produced from batch to batch and can even result in batches that do not result in soap having the desired quality. These challenges related to small-scale production of soap discourages many individuals from attempting to make soap or results in individuals abandoning soap making.

Other known systems and methods include those used for large-scale production of soap. These large-scale, or industrial, systems and methods, require substantial capital investments to install and operate. Using or acquiring such large-scale industrial systems are not feasible for most individuals and organizations. Furthermore, these known large-scale industrial systems to not lend themselves to making small-batch custom soaps that are desired by many of today's health and environmentally conscience consumers.

Accordingly, there is a need to have an automated natural cold process soap making machine that facilitates safe and consistent production of soap.

### SUMMARY

In concordance with the instant disclosure, an automated cold process soap making machine, has surprisingly been discovered.

The present technology includes articles of manufacture, systems, and processes that relate to making soap using an automated cold process.

In certain embodiments, a soap making system can include a lye vessel configured to receive a first material including an ingredient, an oil vessel configured to receive a second material including an ingredient, a blending vessel configured to receive the first material dispensed from the lye vessel and the second material dispensed from the oil vessel, and a control system to facilitate a forming of the soap. The lye vessel can include a lye vessel inlet configured to allow the ingredient of the first material to be deposited into the lye vessel, a lye vessel heat energy source to heat the first material, a lye vessel mixer to blend the first material, and a lye vessel outlet configured to selectively allow the first material to be dispensed from the lye vessel. The oil vessel can include an oil vessel inlet configured to allow the ingredient of the second material to be deposited into the oil vessel, an oil vessel heat energy source to heat the second material, an oil vessel mixer to blend the second material, and an oil vessel outlet configured to selectively allow the second material to be dispensed from the oil vessel. The blending vessel can include a blending vessel mixer to blend the first material with the second material to form a mix of the first material and the second material to produce a soap. The control system can be in communication with the lye vessel, the oil vessel, and the blending vessel. The control system can selectively control one or more of the lye vessel inlet, the lye vessel heat energy source, the lye vessel mixer, the lye vessel outlet, the oil vessel inlet, the oil vessel heat energy source, the oil vessel mixer, the oil vessel outlet, and the blending vessel mixer.

In certain embodiments the soap making system can include a lye vessel configured to receive a first material including an ingredient, an oil vessel configured to receive a second material including an ingredient, a blending vessel configured to receive the first material dispensed from the lye vessel and the second material dispensed from the oil vessel, and a control system to facilitate a forming of the soap. The lye vessel can include including a lye vessel inlet configured to allow the ingredient of the first material to be deposited into the lye vessel, a lye vessel heat energy source to heat the first material, a lye vessel mixer to blend the first material, a lye vessel outlet configured to selectively allow the first material to be dispensed from the lye vessel, and a lye vessel sensor disposed in the lye vessel, wherein the lye vessel sensor can measure an attribute including the first material and/or the ingredient of the first material. The oil vessel can include an oil vessel inlet configured to allow the ingredient of the second material to be deposited into the oil vessel, an oil vessel heat energy source to heat the second material, an oil vessel mixer to blend the second material, an oil vessel outlet configured to selectively allow the second material to be dispensed from the oil vessel, and an oil vessel sensor disposed in the oil vessel, wherein the oil vessel sensor can measure an attribute of the second material and/or the ingredient of the second material. The blending vessel can include a blending vessel mixer to blend the first material with the second material to form a mix of the first material and the second material to produce a soap, and a blending vessel sensor disposed in the blending vessel, wherein the blending vessel sensor can measure an attribute of the first material, the second material, and/or the soap. The control system can be in communication with the lye vessel sensor, the oil vessel sensor, and the blending vessel sensor. The control system can selectively control the lye vessel inlet, the lye vessel heat energy source, the lye vessel mixer, the lye vessel outlet, the oil vessel inlet, the oil vessel heat energy source, the oil vessel mixer, the oil vessel outlet, and/or the blending vessel mixer.

Embodiments of the present disclosure may also include a method of making soap, including a step of providing a soap making system as described herein. The method of making soap can also include the steps of dispensing water into the lye vessel primary chamber of the lye vessel, dispensing sodium hydroxide into the lye vessel secondary chamber of the lye vessel, releasing the sodium hydroxide from the lye vessel primary chamber into the lye vessel secondary chamber, blending the water and the sodium hydroxide in the lye vessel to form a first material, dispensing a second material into the oil vessel, dispensing the first material and the second material into the blending vessel, mixing the first material and the second material in the blending vessel to form the soap, and removing the soap from the blending vessel.

The soap making system can be automated to facilitate utilizing a natural cold process to make soap. The soap making system can be an automated “smart” natural cold process soap making machine that can use technologies such as deep machine learning, data cloud, smart sensors and blockchain technologies. The machine hardware can use software and programing to make the unit “smart.” The soap making system can include recipes for use such that a person making soap can utilize a digital control panel interface of the soap making system to select a desired recipe. Data from an operation of the soap making system, during the process of making soap, can be captured and analyzed by deep machine learning. The deep machine learning can help improve the soap making process and recipes to better improve customer experience, establish key partnerships, and refine the perfect soap product. The soap making system can automatically dispense the right amount of oils and sodium hydroxide solution as called for in the recipe or the makers batch, allowing the user to reduce human error in recipe calculation and minimize production time. The soap making system can also reduce the risk of human injury by having an automated mechanical mixing feature inside the lye tank to properly mix and store the sodium hydroxide that substantially prevents the user from coming into contact with the sodium hydroxide solution and any fumes therefrom.

The soap making system can include an oil tank or vessel and a lye (e.g., sodium hydroxide) tank or vessel. Both tanks can each have a built-in heating system and a sensor such as a scale. The lye tank can have an automated feature that will automatically mix the lye when the lye tank is sealed. These tanks can include a digital panel in the center portion and provide control functions such as dispensing the right amount of oils and lye. The soap making system can include a mixing pot or a blending vessel to facilitate mixing the lye solution with the oil to form the soap.

The lye tank can include automated mixing of the sodium hydroxide. In a primary portion of the lye tank, water can be held. Pellets or sodium hydroxide powder can be held in a separate dry chamber within the lye tank, keeping the water and sodium hydroxide separate from each other at this point in the soap making process to prevent the creation of any fumes. After the pellets or powder are provided, the lye tank can be closed and sealed to keep the fumes in the tank. The dry chamber can open once the lye tank is closed and sealed. The dry chamber can release the sodium hydroxide pellets or powder into the water and self-mixing with an automated mixer within to form a master batched sodium hydroxide solution or first material including the ingredients of water and sodium hydroxide. The master batched sodium hydroxide solution can naturally heat and cool down inside the lye tank locking in fumes and any condensation created. The sodium hydroxide solution can be stored inside the lye tank for about within 3-4 weeks or even longer to make batches of soap.

The soap making system can include a built-in control system having digital and/or manual controls and an associated control digital panel and sensors such as a scale and temperature sensors, for example. The control system can facilitate the dispensing of the materials, control the mixing mechanism and control the soap making system. The control system can utilize software to enable a user to select pre-programmed soap recipes and desired quantities for a batch of soap to reduce human error in the soap making process. For example, if 50 lbs of soap is desired, the control panel can provide the weight of oils and sodium hydroxide needed for this weight of soap. Options to customize can be provided such as % of super fatting. Once the desired weights are selected, the tanks can dispense the oils (the second material) first and then the sodium hydroxide solution (the first material) into the same mixing pot or blending vessel. This will also remove the need for a floor scale since the machine can calculate the weight of each ingredient and/or the first material and the second material when the batch size of the soap is selected. Other options of customization for recipes can also be provided including with medium to large models and commercial versions of the soap making system.

After dispensing the oils and the lye into the mixing pot, the oils and the lye can be blended together. The blending can be done manually. Alternatively, the mixing pot can include a mixer and sensors disposed at different locations. As the mixer blends the oil and lye, the sensors can sense conditions of the blended material such as temperature and viscosity, for example, and use the conditions as feedback to the system to help control the mixer and determine when mixing should stop and the blended material be poured from the mixing pot. This can reduce overly mixing a batch and/or have the soap harden too quickly in the pot or while dispensing into molds. Deep Machine learning can help to gauge the right timing for this blending and dispensing process. A batch that is too thin and liquid-like can start separating and a batch that is too thick can harden in the pot while dispensing. The mixing pot can dispense the soap without being tilted to help to reduce spilling the soap.

Every step of the soap making process can be tracked and recorded through blockchain or data cloud technology. This can help the customers stay updated on the products being manufactured for them. This can also help to track batches that may need to be recalled or reworked, as well as militate against counterfeit product from entering the marketplace and build trust and transparency.

A real time tracking of data from the soap making system can help an operator scale up production, track inventory, re-order raw material(s), and provide customers with transparency and build trust. With an established partnership with a raw material supplier, this data can be used for reordering and tracking raw material more efficiently.

The soap making system can utilize deep machine learning. Data can be captured from the soap making system and can be analyzed to facilitate optimizing recipes and operational parameters of the machine. In effect, the data from the soap making system can facilitate the production of continuous improvement of soap bar recipes, manufacturing process, and the final soap product.

The physical appearance of the soap making system can have an overall modern and sleek appearance. The two chamber tanks, one for oils and one for lye, can be disposed side-by-side with the digital control panel that provides an interface for the user to operate the soap making system disposed between the two tanks, for example. Modern sleek, futuristic, stainless-steel material can be used to promote durability and safety of the machine. Energy efficiency can be enhanced since both oil and lye chambers need to be heated and having the tanks in close proximity can facilitate a heat transfer between the tanks to help keep both tanks to warm. Furthermore, the built in heaters and scales can be provided to reduce production time by heating oils and lye solution at the same time to the desired temperature. This can eliminate the need to purchase separate equipment like a heater and tank heater jackets for both tanks.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A and 1B depict a block diagram of a soap making system, according to an embodiment of the present disclosure;

FIG. 2 is a perspective view of a soap making system, according to an embodiment of the present disclosure;

FIG. 3 is a fragmentary front elevational view of the soap making system of FIG. 2; and

FIGS. 4A and 4B depict a flowchart illustrating a method of making soap, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology provides improved cold process soap making machines, systems, and methods.

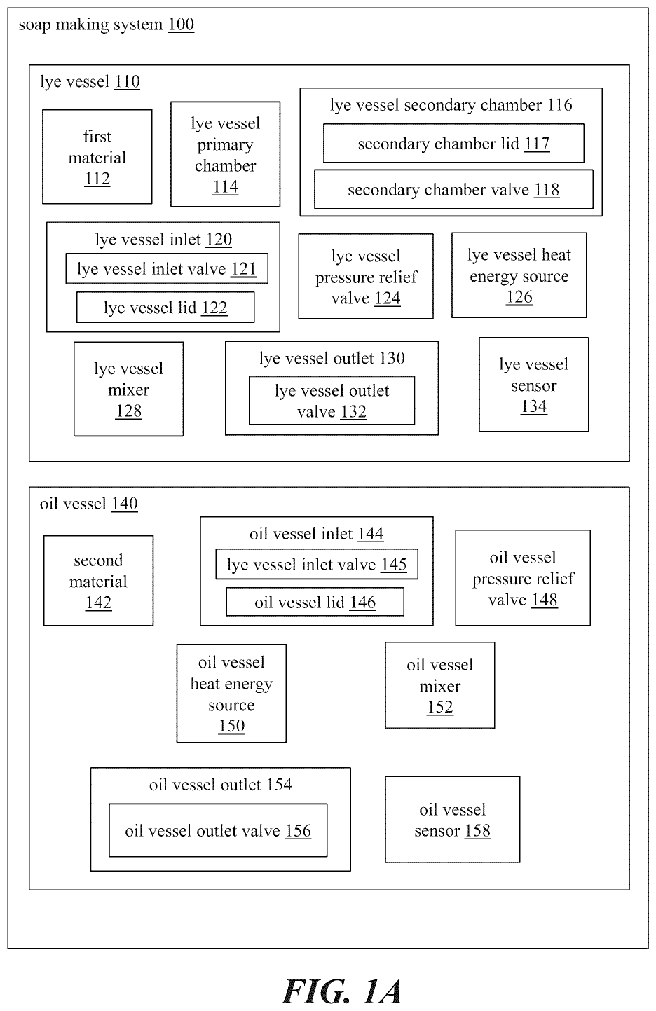

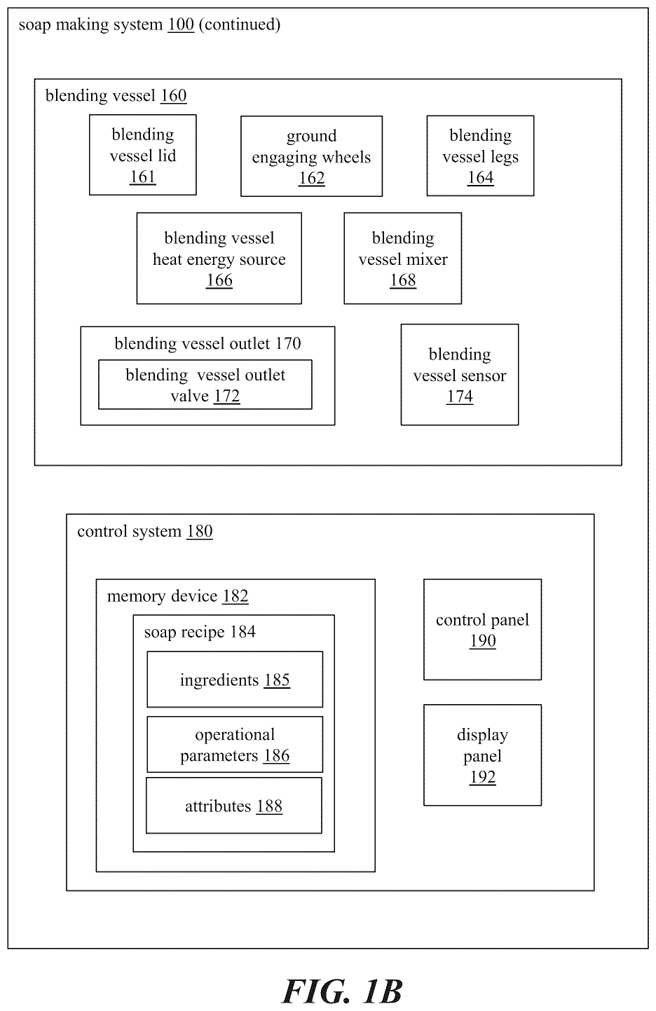

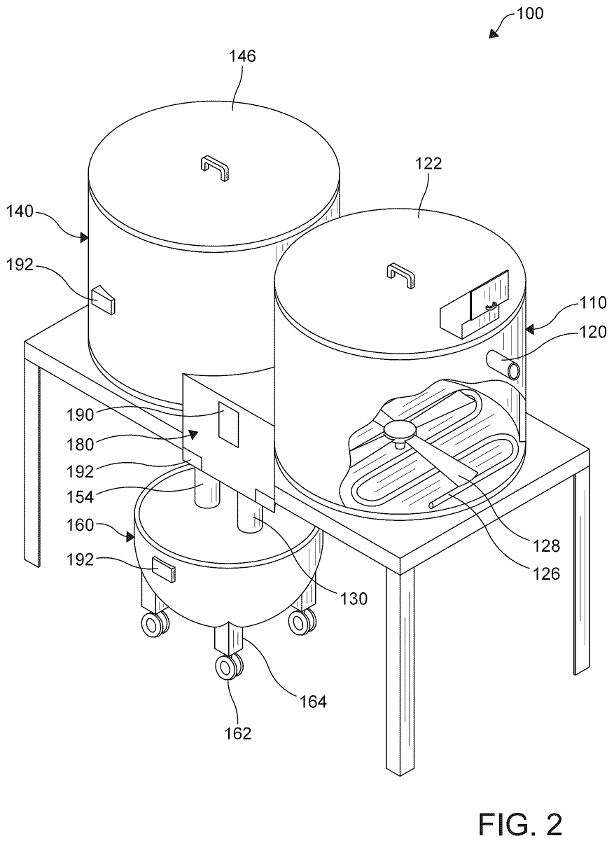

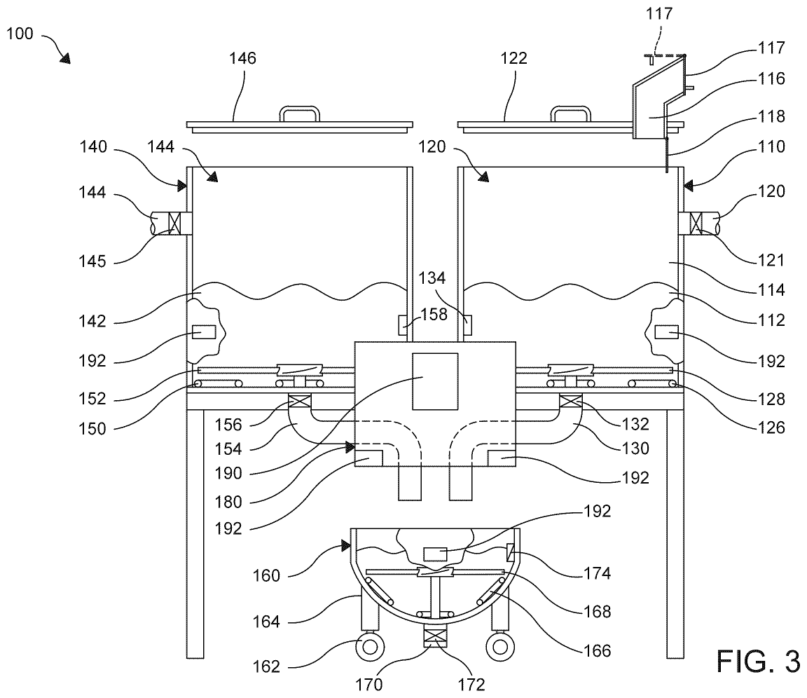

FIGS. 1A and 1B depict a block diagram of aspects applicable to a soap making system 100 constructed in accordance with the present disclosure. Additional aspects of the soap making system 100 are further shown in FIGS. 2 and 3. The soap making system 100 can include a lye vessel 110, an oil vessel 140, a blending vessel 160, and a control system 180. The lye vessel 110 can be configured to receive a first material 112. The first material 112 can include the ingredients of water and lye (e.g., sodium hydroxide) for making the soap. It should be understood that one or more various additives can be provided as ingredients, as desired, to facilitate the processing of the first material 112, the formation of soap, and the characteristics of the soap, for example.

The lye vessel 110 may include a lye vessel primary chamber 114 for holding the first material 112 and/or an ingredient thereof and a lye vessel secondary chamber 116 for holding the first material 112 and/or an ingredient thereof. In some embodiments, the lye vessel primary chamber 114 is configured to receive water and the lye vessel secondary chamber 116 is configured to receive the lye (e.g., sodium hydroxide). It should be understood that the sodium hydroxide may be provided in a liquid, powder, granular, and/or solid form. Furthermore, the sodium hydroxide can be provided in a pre-measured container and/or pod, for example, where the container or pod substantially prevents the user from directly contacting the sodium hydroxide while making the soap. The lye vessel secondary chamber 116 can include a secondary chamber lid 117 to selectively close the lye vessel secondary chamber 116 and a secondary chamber valve 118 to selectively release the first material 112 and/or an ingredient held therein to the lye vessel primary chamber 114.

The lye vessel 110 can include a lye vessel inlet 120 for allowing the first material 112 and/or an ingredient thereof to be deposited into the lye vessel 110. In certain embodiments, and as shown in FIGS. 1A, 2, and 3, the lye vessel inlet 120 can include a lye vessel lid 122 configured to selectively close and seal an open end of the lye vessel 110. Furthermore, the lye vessel lid 122 can include the lye vessel secondary chamber 116 where the first material 112 and/or an ingredient held therein, such as the sodium hydroxide, for example, is released to the lye vessel primary chamber 114 upon the lye vessel lid 122 closing and forming a substantially fluid tight seal with the lye vessel primary chamber 114.

In certain embodiments, the lye vessel inlet 120 can include a lye vessel inlet valve 121 in communication with a source of the first material 112 and/or an ingredient thereof, where the lye vessel inlet valve 121 can be opened to allow the first material 112 and/or an ingredient thereof to be deposited into the lye vessel 110. It should be understood that more than one lye vessel inlet 120 can be provided to allow for separately allowing the first material 112 and/or an ingredient thereof to be deposited into the lye vessel 110. Additionally, the lye vessel inlet 120 can be positioned to allow the first material 112 and/or an ingredient thereof to be deposited in one or both of the lye vessel primary chamber 114 and the lye vessel secondary chamber 116.

The lye vessel 110 can also include a lye vessel pressure relief valve 124 to provide a fluid escape path from an interior of the lye vessel 110 and maintain a desired fluid pressure within the lye vessel 110. The lye vessel pressure relief valve 124 can be in fluid communication with an exhaust system configured to collect and/or discharge fluid passing through the lye vessel pressure relief valve 124 and mitigate against the fluid passing through the lye vessel pressure relief valve 124 from contacting or being inhaled by a user of the soap making system 100 and others.

The lye vessel 110 can include a lye vessel heat energy source 126 to heat the first material 112 and/or the ingredient thereof held in the lye vessel 110. The lye vessel 110 can also include a lye vessel mixer 128 to blend the first material 112 and/or the ingredients thereof to facilitate forming the first material 112. Additionally, the lye vessel 110 can include a lye vessel outlet 130 to selectively allow the first material 112 and/or the ingredients thereof to be selectively dispensed from the lye vessel 110. The lye vessel outlet 130 can include a lye vessel outlet valve 132 in fluid communication with the interior of the lye vessel 110, where the lye vessel outlet valve 132 can be opened to allow the first material 112 and/or the ingredient thereof to be dispensed from the lye vessel 110.

A lye vessel sensor 134 can be disposed in the lye vessel 110 and/or in communication with the interior of the lye vessel 110. The lye vessel sensor 134 can be in contact with and/or in communication with the first material 112 and/or the ingredients thereof as well as the lye vessel primary chamber 114, the lye vessel secondary chamber 116, the secondary chamber valve 118, the lye vessel inlet 120 and/or the lye vessel lid 122, the lye vessel pressure relief valve 124, the lye vessel heat energy source 126, the lye vessel mixer 128, the lye vessel outlet 130 and/or the lye vessel outlet valve 132. It should be understood that more than one lye vessel sensor 134 can be provided, as desired. The lye vessel sensor 134 can be configured to measure an attribute of the first material 112 and/or the ingredients thereof such as a temperature, a weight, a volume, a viscosity, and/or a composition. The lye vessel sensor 134 can also be configured to sense an operating condition and/or control a function of the lye vessel primary chamber 114, the lye vessel secondary chamber 116, the secondary chamber valve 118, the lye vessel inlet 120 and/or the lye vessel lid 122, the lye vessel pressure relief valve 124, the lye vessel heat energy source 126, the lye vessel mixer 128, the lye vessel outlet 130 and/or the lye vessel outlet valve 132.

The oil vessel 140 of the soap making system 100 can be configured to receive and hold a second material 142. The second material 142 can include the ingredients of one or more types of oils and/or fats. It should also be understood that one or more additives can be provided as ingredients, as desired, to facilitate the processing of the second material 142, the formation of soap, and the characteristics of the soap, such as scented, abrasive, and decorative materials, for example.

The oil vessel 140 can include an oil vessel inlet 144 for allowing the second material 142 and/or an ingredient thereof to be deposited into the oil vessel 140. In certain embodiments, and as shown in FIGS. 1A and 3, the oil vessel inlet 144 can include an opening into the top portion of the oil vessel inlet. In some embodiments, the oil vessel 140 can include an oil vessel lid 146 to selectively close and substantially seal the oil vessel inlet 144. In certain embodiments, the oil vessel inlet 144 can be an oil vessel inlet valve 145 in communication with a source of the second material 142 and/or an ingredient thereof, where the oil vessel inlet valve 145 can be opened to allow the second material 142 and/or an ingredient thereof to be deposited into the oil vessel 140. It should be understood that more than one oil vessel inlet 144 can be provided to allow for separately allowing the second material 142 and/or an ingredient thereof to be deposited into the oil vessel 140.

The oil vessel 140 can also include an oil vessel pressure relief valve 148 to provide a fluid escape path from an interior of the oil vessel 140 and maintain a desired fluid pressure within the oil vessel 140. The oil vessel pressure relief valve 148 can be in fluid communication with an exhaust system configured to collect and/or discharge fluid passing through the oil vessel pressure relief valve 148 and mitigate against the fluid passing through the oil vessel pressure relief valve 148 from contacting or being inhaled by a user of the soap making system 100 and others.

The oil vessel 140 can include an oil vessel heat energy source 150 to heat the second material 142 and/or the ingredient thereof held in the oil vessel 140. The oil vessel 140 can also include an oil vessel mixer 152 to blend the second material 142 and/or the ingredients thereof to facilitate forming the second material 142. Additionally, the oil vessel 140 can include an oil vessel outlet 154 to selectively allow the second material 142 and/or the ingredients thereof to be selectively dispensed from the oil vessel 140. The oil vessel outlet 154 can include an oil vessel outlet valve 156 in fluid communication with an interior of the oil vessel 140, where the oil vessel outlet valve 156 can be opened to allow the second material 142 and/or the ingredient thereof to be dispensed from the oil vessel 140.

An oil vessel sensor 158 can be disposed in the oil vessel 140 and/or in communication with the interior of the oil vessel 140. The oil vessel sensor 158 can be in contact with or in communication with the second material 142 and/or the ingredients thereof as well as the oil vessel inlet 144, the oil vessel lid 146, the oil vessel pressure relief valve 148, the oil vessel heat energy source 150, the oil vessel mixer 152, the oil vessel outlet 154 and/or the oil vessel outlet valve 156. It should be understood that more than one oil vessel sensor 158 can be provided, as desired. The oil vessel sensor 158 can be configured to measure an attribute of the second material 142 and/or the ingredients thereof such as a temperature, a weight, a volume, a viscosity, and/or a composition. The oil vessel sensor 158 can also be configured to sense an operating condition of and control a function of the oil vessel inlet 144, the oil vessel lid 146, the oil vessel pressure relief valve 148, the oil vessel heat energy source 150, the oil vessel mixer 152, the oil vessel outlet 154 and/or the oil vessel outlet valve 156.

The blending vessel 160 of the soap making system 100 can be configured to receive the first material 112 dispensed from the lye vessel 110 and the second material 142 dispensed from the oil vessel 140. In certain embodiments and as shown in FIGS. 2 and 3, the blending vessel 160 can be an open receptacle such as a pot. It should be understood that the blending vessel 160 can have other shapes, sizes, and configurations as desired, including but not limited to cylinders, cubes, trays, and pans, for example. It should also be understood that the soap making system 100 can include more than one blending vessel 160 to facilitate making the soap.

In certain embodiments, the blending vessel 160 can include a blending vessel lid 161 to selectively close and/or substantially seal the blending vessel 160. The blending vessel lid 161 can be utilized to help control the rate of cooling of the contents therein and mitigate against an undesired material from being received by the blending vessel 160 and incorporated into the soap. Additionally, it should be understood that the blending vessel 160 can be mobile by providing ground engaging wheels 162 at the ends of legs 164, or a bottom surface, of the blending vessel 160. The ground engaging wheels 162 can facilitate moving the blending vessel 160 into position to receive the first material 112 dispensed from the lye vessel 110 and the second material 142 dispensed from the oil vessel 140, and then can facilitate relocating the blending vessel 160 to other locations as desired.

The blending vessel 160 can include a blending vessel heat energy source 166 to heat the first material 112 and second material 142 received therein. The blending vessel 160 can also include a blending vessel mixer 168 to blend the first material and the second material 142 to facilitate forming the soap. Additionally, the blending vessel 160 can include a blending vessel outlet 170 to selectively allow the soap and/or the blend of the first material 112 and the second material 142 to be selectively dispensed from the blending vessel 160. The blending vessel outlet 170 can include a blending vessel outlet valve 172 in fluid communication with an interior of the blending vessel 160, where the blending vessel outlet valve 172 can be selectively opened to dispense the soap and/or the blend of the first material 112 and the second material 142 from the blending vessel 160. It should be understood that the soap and/or the blend of the first material 112 and the second material 142 can be dispensed into soap molds, cooling trays, or the like to facilitate completing the soap making process and providing a desired configuration and/or shape to the soap.

A blending vessel sensor 174 can be disposed in the blending vessel 160 and/or in communication with an interior of the blending vessel 160. The blending vessel sensor 174 can be in contact with or in communication with the soap and/or the blend of the first material 112 and the second material 142, as well as the blending vessel lid, the blending vessel heat energy source 166, the blending vessel mixer 168, the blending vessel outlet 170, and/or the blending vessel outlet valve 172. It should be understood that more than one blending vessel sensor 174 can be provided, as desired. The blending vessel sensor 174 can be configured to measure an attribute of the soap and/or the blend of the first material 112 and the second material 142 such as a temperature, a weight, a volume, a viscosity, and/or a composition. The blending vessel sensor 174 can also be configured to sense an operating condition of and control a function of the blending vessel lid, the blending vessel heat energy source 166, the blending vessel mixer 168, the blending vessel outlet 170, and/or the blending vessel outlet valve 172.

The control system 180 of the soap making system 100 can be configured to facilitate a forming of the soap through initiating, monitoring, recording, and controlling the operation of the soap making system 100. The control system 180 can be in communication with the lye vessel sensor 134, the oil vessel sensor 158, and the blending vessel sensor 174. The control system can cooperate with the sensors 134, 158, 174 to selectively sense, control, and record the operation of one or more of the lye vessel primary chamber 114, the lye vessel secondary chamber 116, the secondary chamber valve 118, the lye vessel inlet 120 and/or the lye vessel lid 122, the lye vessel pressure relief valve 124, the lye vessel heat energy source 126, the lye vessel mixer 128, the lye vessel outlet 130 and/or the lye vessel outlet valve 132, the oil vessel inlet 144, the oil vessel lid 146, the oil vessel pressure relief valve 148, the oil vessel heat energy source 150, the oil vessel mixer 152, the oil vessel outlet 154 and/or the oil vessel outlet valve 156, the blending vessel lid, the blending vessel heat energy source 166, the blending vessel mixer 168, the blending vessel outlet 170, and/or the blending vessel outlet valve 172.

The control system 180 can include a memory device 182 configured to store a soap recipe 184. It should be understood that the soap recipe 184 can include ingredients 185 for the soap, including the type and target amounts thereof. The control system 180 can also scale the soap recipe 184 to a particular desired batch size based on the user inputting a desired quantity of the soap. The scaling of the soap recipe 184 by the control system 180 can minimize errors from manual calculations and scaling processes typically utilized by soap makers.

The soap recipe 184 can also include operational parameters 186 for making the soap, such as mixing times and temperatures of the ingredients 185, the first material 112, the second material 142, and the soap. The soap recipe 184 can also include attributes 188 for the ingredients 185, the first material 112, the second material 142, and the soap. Further examples of items included in the soap recipe 184 can include, but are not limited to, the following: a quantity of the first material 112 to be dispensed in the lye vessel 110; a quantity of the ingredients of the first material 112 to be dispensed in the lye vessel 110; a target value of an attribute of the first material 112; the ingredient of the second material 142; a quantity of a second material 142 to be dispensed in the oil vessel 140; a quantity of an ingredient of the second material 142 to be dispensed in the oil vessel 140; a target value of an attribute of the second material 142; a quantity of the first material 112 to be dispensed in the blending vessel 160; a quantity of the second material 142 to be dispensed in the blending vessel 160; a target value of an attribute of the first material 112, the second material 142, the blend of the first material 112 and the second material 142, and the soap in the blending vessel 160. It should be understood that the memory device 182 can also be configured to store actual values related to the soap making system 100 completing a recipe and making a batch of the soap. Furthermore, the actual operational parameters detected by the sensors 134, 158, 174 can be utilized as feedback to determine when certain operations should be initiated and/or stopped such as stopping mixing when a target viscosity is achieved, adding heat energy when the materials 112, 142 fall below a target temperature, and when to release the materials 112, 142 to the blending vessel 160.

Additionally, the operational parameters recorded by the control system 180 to the memory device 182 can be analyzed to facilitate identify process/recipe improvements, monitoring the quality of completed batches of soap, and identifying any batches not conforming to selected quality targets and tolerances. It should be understood that artificial intelligence, machine learning, and the like can be utilized and/or incorporated into the control system 180 to facilitate such analysis.

Furthermore, the consumption of ingredients, the first material 112, and the second material 142 can be tracked and utilized to facilitate replenishing such items from suppliers. It should be understood that the control system 180 can be in communication with suppliers to facilitate the automation of ordering such items from suppliers. It should also be understood that the control system 180 can also provide the amount of soap (weight) produced to facilitate tracking and management of the inventory of the soap.

A control panel 190 and one or more display panels 192 can be provided for the control system 180. The control panel 190 can be configured to allow the user to provide inputs to the control system 180, such as selecting the soap recipe 184 or manual operation of a function of the soap making system 100. Additionally, the control panel 190 and the display panels 192 can be configured to provide real-time display of the operational parameters 186 and/or attributes 188 as well as other data collected and/or recorded related to the operation of the soap making system 100.

It should be understood that the control system 180 can be in communication with remote computing devices and data storage devices to facilitate the operation of the soap making system 100, the recordation of the soap recipe 184, recordation of the actual operational parameters, and analysis of the actual operational parameters, for example. Additionally, a computer application can be provided for a smart phone, tablet, laptop, desktop, or other suitable electronic device to interface with the control system 180 and enable the user to operate and monitor the soap making system 100 utilizing the electronic device.

In use, one or more of the soap recipes 184 can be stored in the memory device 182 of the control system 180 of the soap making system 100. The user can then select the soap recipe 184 and the quantity of the soap desired for a batch of the soap utilizing the control panel 190. The control system 180 can then calculate the amount of each ingredient for the first material 112 and the second material 142 required for the desired batch of the soap. In certain embodiments, the user can measure and add the ingredients for the first material 112 to the lye vessel 110 and the ingredients for the second material 142 to the oil vessel 140. In certain embodiments, one or more of the ingredients for the first material 112 and the second material 142 can be automatically dispensed to the lye vessel 110 and the oil vessel 140 through the lye vessel inlet 120 and the oil vessel inlet 140. The sensors 134, 158 can then detect and communicate initial operational parameters 186 to the control system 180 which can be used to determine the processing parameters such as mixing times and heating requirements, for example, to produce the batch of the soap. The control system 180 can then initiate the required functional operation of the soap making system 100 to produce the batch of the soap, including but not limited to energizing the lye vessel heat energy source 126, the lye vessel mixer 128, the oil vessel heat energy source 150, the oil vessel mixer 152. The control system 180 can utilize the sensors 134, 158 to monitor the attributes 188 of the first material 112 and the second material 142. The control system 180 can adjust the operational parameters 186 in order to achieve the desired attributes of the first material 112 and the second material 142. Furthermore, when the first material 112 and the second material 142 are processed and detected by the sensors 134, 158 to have achieved the desired attributes, the control system 180 can cease the operation of the lye vessel heat energy source 126, the lye vessel mixer 128, the oil vessel heat energy source 150, and the oil vessel mixer 152, and initiate the dispensing of the first material 112 and the second material 142 to the blending vessel 160 utilizing the lye vessel outlet 130 and the oil vessel outlet 154, respectively.

Upon receipt of the first material 112 and the second material 142 by the blending vessel 160, the control system 180 can then initiate the required functional operation of the blending vessel 160, including but not limited to energizing the blending vessel heat energy source 166 and the blending vessel mixer 168. The control system 180 can utilize the blending vessel sensor 174 to monitor the mixing of the first material 112 and the second material 142 as the soap is formed. The control system 180 can adjust the operational parameters 186 relative to the blending vessel 160 in order to achieve the desired attributes of the soap being formed therein. Furthermore, when the soap being processed in the blending vessel 160 is detected by the blending vessel sensor 174 to have achieved the desired attributes, the control system 180 can cease the operation of the blending vessel heat energy source 166 and the blending vessel mixer 168, and provide a notice to the user that the batch of soap is complete and/or initiate the dispensing of the soap to a soap mold or cooling tray, for example, utilizing the blending vessel outlet 170.

When the batch of soap is complete, the user can utilize the control system 180 to review and analyze the completed process of making the batch of soap. As a non-limiting example, the review of the completed process can include comparing actual operational parameters and values to target operational parameters and values from the soap recipe 184. As another non-limiting example, the analysis of the completed process can include a manual analysis as well as an analysis utilizing tools such as artificial intelligence, statistics, statistical models, machine learning technologies, algorithms, and the like.

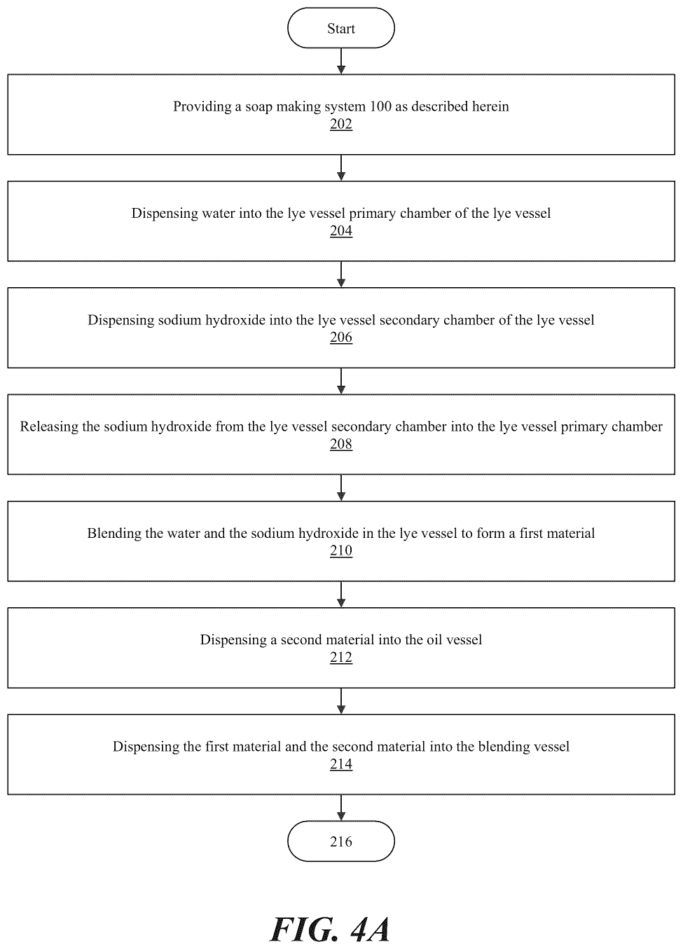

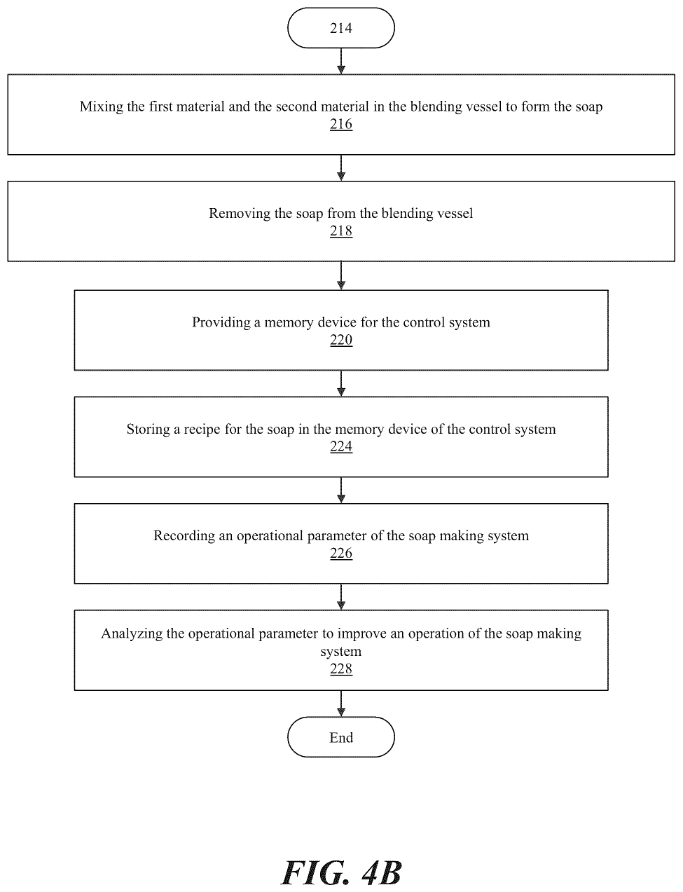

FIGS. 4A and 4B are a flowchart that describe a method 200 of making soap, according to certain embodiments of the present disclosure. The method 200 can include a step 202 of providing the soap making system 100 described herein. The method can include a step 204 of dispensing water into the lye vessel primary chamber 114 of the lye vessel 110. Lye (e.g., sodium hydroxide) can be dispensed into the lye vessel secondary chamber 116 of the lye vessel 110 in a step 206. A step 208 can include releasing the sodium hydroxide from the lye vessel secondary chamber 116 into the lye vessel primary chamber 114. At a step 210, the water and the sodium hydroxide in the lye vessel 110 can be blended to form the first material 112. The second material 142 can be dispensed into the oil vessel 140 at a step 212. A step 214 can include dispensing the first material 112 and the second material 142 into the blending vessel 160. In a step 216, the first material 112 and the second material 142 in the blending vessel 160 can be mixed to form the soap. At a step 218, the soap can be removed from the blending vessel 160.

The method 200 can also include one of more of the following: a step 220 of providing a memory device 182 for the control system 180; a step 222 of storing a soap recipe 184 for the soap in the memory device 182 of the control system 180; a step 224 of recording an operational parameter 186 of the soap making system 100; and a step 226 of analyzing the operational parameter 186 to improve an operation of the soap making system 100.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A soap making system comprising:
a lye vessel configured to receive a first material, the first material including an ingredient,
the lye vessel including
a lye vessel inlet configured to allow the ingredient of the first material to be deposited into the lye vessel,
a lye vessel heat energy source to heat the first material,
a lye vessel mixer to blend the first material, and
a lye vessel outlet configured to selectively allow the first material to be dispensed from the lye vessel;
an oil vessel configured to receive a second material, the second material including an ingredient,
the oil vessel including
an oil vessel inlet configured to allow the ingredient of the second material to be deposited into the oil vessel,
an oil vessel heat energy source to heat the second material,
an oil vessel mixer to blend the second material, and
an oil vessel outlet configured to selectively allow the second material to be dispensed from the oil vessel;
a blending vessel configured to receive the first material dispensed from the lye vessel and the second material dispensed from the oil vessel,
the blending vessel including
a blending vessel mixer to blend the first material with the second material to form a mix of the first material and the second material to produce a soap; and
a control system to facilitate a forming of the soap, the control system in communication with the lye vessel, the oil vessel, and the blending vessel, the control system selectively controlling a member selected from a group consisting of the lye vessel inlet, the lye vessel heat energy source, the lye vessel mixer, the lye vessel outlet, the oil vessel inlet, the oil vessel heat energy source, the oil vessel mixer, the oil vessel outlet, the blending vessel mixer, and combinations thereof.

2. The soap making system of claim 1, wherein the lye vessel inlet includes a lye vessel inlet valve having an open position and a closed position, and the lye vessel outlet includes a lye vessel outlet valve having an open position and a closed position.

3. The soap making system of claim 2, further comprising a first material, the first material including an ingredient selected from a group consisting of water, sodium hydroxide, and an additive material, and combinations thereof, wherein the lye vessel includes the first material.

4. The soap making system of claim 3, wherein the lye vessel includes
a lye vessel primary chamber for holding the water; and
a lye vessel secondary chamber for holding the sodium hydroxide, the lye vessel secondary chamber in communication with the lye vessel primary chamber to selectively release the sodium hydroxide into the lye vessel primary chamber when the lye vessel inlet valve and the lye vessel outlet valve are in the closed position.

5. The soap making system of claim 3, further comprising a lye vessel sensor disposed in the lye vessel, wherein the lye vessel sensor measures an attribute of a member selected from a group consisting of the first material, the ingredient of the first material, and combinations thereof and communicates the attribute to the control system.

6. The soap making system of claim 5, wherein the attribute includes a member selected from a group consisting of a weight, a volume, a viscosity, a temperature, and combinations thereof.

7. The soap making system of claim 1, wherein the oil vessel outlet of the oil vessel includes an oil vessel outlet valve, the oil vessel outlet valve having an open position and a closed position.

8. The soap making system of claim 1, further comprising a second material, the second material including an ingredient selected from a group consisting of oil, an additive material, and combinations thereof, wherein the oil vessel includes the first material.

9. The soap making system of claim 8, further comprising an oil vessel sensor disposed in the oil vessel, wherein the oil vessel sensor measures an attribute of a member selected from a group consisting of the second material, the ingredient of the second material, and combinations thereof and communicates the attribute to the control system.

10. The soap making system of claim 9, wherein the attribute includes a member selected from a group consisting of a weight, a volume, a viscosity, a temperature, and combinations thereof.

11. The soap making system of claim 1, further comprising a blending vessel heat energy source disposed in the blending vessel to heat the mix of the first material and the second material held in the blending vessel.

12. The soap making system of claim 1, further comprising a blending vessel sensor disposed in the blending vessel, wherein the blending vessel sensor measures an attribute of a member selected from a group consisting of the first material, the second material, the soap, and combinations thereof and communicates the attribute to the control system.

13. The soap making system of claim 12, wherein the attribute includes a member selected from a group consisting of a weight, a volume, a viscosity, a third temperature, and combinations thereof.

14. The soap making system of claim 1, wherein the control system includes a memory device, and the memory device includes a member selected from a group consisting of a recipe for the soap, an operational parameter of the soap making system, and combinations thereof stored on the memory device.

15. The soap making system of claim 14, wherein the recipe includes a member selected from a group consisting of
a quantity of a first material to be dispensed in the lye vessel,
a quantity of an ingredient of the first material to be dispensed in the lye vessel,
a target value of an attribute of a member selected from a group consisting of the first material, the ingredient of the first material, and combinations thereof in the lye vessel,
a quantity of a second material to be dispensed in the oil vessel,
a quantity of an ingredient of the second material to be dispensed in the oil vessel,
a target value of an attribute of a member selected from a group consisting of the second material, the ingredient of the second material, and combinations thereof in the oil vessel,
a quantity of the first material to be dispensed in the blending vessel,
a quantity of the second material to be dispensed in the blending vessel,
a target value of an attribute of a member selected from a group consisting of the first material, the second material, and combinations thereof in the blending vessel, and
combinations thereof.

16. A soap making system comprising:
a lye vessel configured to receive a first material, the first material including an ingredient,
the lye vessel including
a lye vessel inlet configured to allow the ingredient of the first material to be deposited into the lye vessel,
a lye vessel heat energy source to heat the first material,
a lye vessel mixer to blend the first material,
a lye vessel outlet configured to selectively allow the first material to be dispensed from the lye vessel, and
a lye vessel sensor disposed in the lye vessel, wherein the lye vessel sensor measures an attribute of a member selected from a group consisting of the first material, the ingredient of the first material, and combinations thereof;
an oil vessel configured to receive a second material, the second material including an ingredient,
the oil vessel including
an oil vessel inlet configured to allow the ingredient of the second material to be deposited into the oil vessel,
an oil vessel heat energy source to heat the second material,
an oil vessel mixer to blend the second material,
an oil vessel outlet configured to selectively allow the second material to be dispensed from the oil vessel, and
an oil vessel sensor disposed in the oil vessel, wherein the oil vessel sensor measures an attribute of a member selected from a group consisting of the second material, the ingredient of the second material, and combinations thereof;
a blending vessel configured to receive the first material dispensed from the lye vessel and the second material dispensed from the oil vessel,
the blending vessel including
a blending vessel mixer to blend the first material with the second material to form a mix of the first material and the second material to produce a soap, and
a blending vessel sensor disposed in the blending vessel, wherein the blending vessel sensor measures an attribute of a member selected from a group consisting of the first material, the second material, the soap, and combinations thereof; and
a control system to facilitate a forming of the soap, the control system in communication with the lye vessel sensor, the oil vessel sensor, and the blending vessel sensor, the control system selectively controlling a member selected from a group consisting of the lye vessel inlet, the lye vessel heat energy source, the lye vessel mixer, the lye vessel outlet, the oil vessel inlet, the oil vessel heat energy source, the oil vessel mixer, the oil vessel outlet, the blending vessel mixer, and combinations thereof.

17. The soap making system of claim 16, further comprising
a first material, the first material including an ingredient selected from a group consisting of water, sodium hydroxide, and an additive material, and combinations thereof, wherein the lye vessel includes the first material; and
a second material, the second material including an ingredient selected from a group consisting of oil, an additive material, and combinations thereof, wherein the oil vessel includes the first material,
wherein the lye vessel further comprises
a lye vessel primary chamber for holding the water, and
a lye vessel secondary chamber for holding the sodium hydroxide, the lye vessel secondary chamber in communication with the lye vessel primary chamber to selectively release the sodium hydroxide into the lye vessel primary chamber.

18. The soap making system of claim 17, wherein the control system includes
a memory device including a member selected from a group consisting of a recipe for the soap, an operational parameter of the soap making system, and combinations thereof stored on the memory device,
wherein the recipe includes a member selected from a group consisting of
a quantity of the first material to be dispensed in the lye vessel,
a quantity of the ingredient of the first material to be dispensed in the lye vessel,
a target value of an attribute of the first material, the ingredient of the first material, and combinations thereof in the lye vessel,
a quantity of a second material to be dispensed in the oil vessel,
a quantity of an ingredient of the second material to be dispensed in the oil vessel,
a target value of an attribute of the second material, the ingredient of the second material, and combinations thereof in the oil vessel,
a quantity of the first material to be dispensed in the blending vessel,
a quantity of the second material to be dispensed in the blending vessel,
a target value of an attribute of the first material, the second material, and combinations thereof in the blending vessel, and
combinations thereof.

19. A method of making soap, comprising steps of:
providing a soap making system comprising,
a lye vessel configured to receive a first material, the first material including an ingredient, the lye vessel including
a lye vessel primary chamber, and a lye vessel secondary chamber, the lye vessel secondary chamber in communication with the lye vessel primary chamber,
a lye vessel inlet configured to allow the ingredient of the first material to be deposited into the lye vessel,
a lye vessel heat energy source to heat the first material,
a lye vessel mixer to blend the first material, and
a lye vessel outlet configured to selectively allow the first material to be dispensed from the lye vessel;
an oil vessel configured to receive a second material, the second material including an ingredient, the oil vessel including
an oil vessel inlet configured to allow the ingredient of the second material to be deposited into the oil vessel,
an oil vessel heat energy source to heat the second material,
an oil vessel mixer to blend the second material, and
an oil vessel outlet configured to selectively allow the second material to be dispensed from the oil vessel;
a blending vessel configured to receive the first material dispensed from the lye vessel and the second material dispensed from the oil vessel, the blending vessel including
a blending vessel mixer to blend the first material with the second material to form a mix of the first material and the second material to produce a soap; and
a control system to facilitate a forming of the soap, the control system in communication with the lye vessel, the oil vessel, and the blending vessel, the control system selectively controlling a member selected from a group consisting of the lye vessel inlet, the lye vessel heat energy source, the lye vessel mixer, the lye vessel outlet, the oil vessel inlet, the oil vessel heat energy source, the oil vessel mixer, the oil vessel outlet, the blending vessel mixer, and combinations thereof;
dispensing water into the lye vessel primary chamber of the lye vessel;
dispensing sodium hydroxide into the lye vessel secondary chamber of the lye vessel;
releasing the sodium hydroxide from the lye vessel secondary chamber into the lye vessel primary chamber;
blending the water and the sodium hydroxide in the lye vessel to form a first material;
dispensing a second material into the oil vessel;
dispensing the first material and the second material into the blending vessel;
mixing the first material and the second material in the blending vessel to form the soap; and
removing the soap from the blending vessel.

20. The method of claim 19, further comprising:
providing a memory device for the control system;
storing a recipe for the soap in the memory device of the control system;
recording an operational parameter of the soap making system; and
analyzing the operational parameter to improve an operation of the soap making system.
